(19) United States
(12) Patent Application Publication
(10) Pub. No.: US 2001/0033962 A1
(43) Pub. Date: Oct. 25, 2001

(54) Sealed battery and method for manufacturing the same

(75) Inventor: Yasuyuki Suzuki, Utsunomiya-Shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: NEC MOBILE ENERGY CORPORATION, Utsunomiya-Shi (JP)

(21) Appl. No.: 09/837,429

(22) Filed: Apr. 19, 2001

(30) Foreign Application Priority Data
Apr. 19, 2000 (JP) 2000-118232

(51) Int. Cl. H01M 6/10; H01M 2/08; H01M 10/04; H01M 2/26

(52) U.S. Cl. 429/94; 429/127; 429/184; 429/211; 29/623.2

(57) ABSTRACT

The present invention provides a sealed battery using an external material made of flexible material, in which there is no need to bend electrode conductive tabs and in which no defective winding occurs around tabs of the battery element. A band-like positive electrode and a band-like negative electrode are laminated one upon another via a separator, and a laminated combination of electrodes is wound up to prepare a battery element, and the battery element is sealed with a flexible external material. Electrode conductive tabs are bonded respectively at outermost periphery of the positive electrode and the negative electrode when the electrodes are wound up, and neither of the electrode conductive tabs is present at central portion of the battery element.

### BACKGROUND OF THE INVENTION

The present invention relates to a sealed battery, which comprises a wound-type battery element, and in particular, to a wound-type battery, which is characterized by the connecting position of a conductive tab on a wound-type combination of electrodes and also by the connecting structure of a conductive connection terminal.

Various types of batteries are used as power sources for small-size electronic devices. As power sources for the devices such as cellular phone, notebook-sized personal computer, camcorder, etc., nonaqueous electrolyte battery such as lithium ion battery, i.e. small-size large-capacity sealed batteries, and batteries of cylindrical structure or rectangular structure are used.

In a lithium ion battery used as power source of small-size electronic device, an active material is coated on a positive electrode current collector and a negative electrode current collector. Then, these are wound up via a separator between them, and it is accommodated in a battery case and is sealed.

However, in a battery using a battery case, metal material such as nickel-plated soft steel or aluminum alloy is used as the case. Then, there is a limitation in producing the battery in small-size and lightweight design, and it is proposed to produce a battery, in which a laminated film such as aluminum film are laminated.

In a sealed battery using the laminated film as flexible external material and sealed with thermally melting synthetic resin film, planar positive electrode and planar negative electrode in the same size as the outline dimension of the battery are laminated via a separator and sealed.

JP-11-54111 proposes a battery using long-size materials for the positive electrode, the negative electrode and the separator. These components are laminated one upon another, and a positive electrode conductive tab and a negative electrode conductive tab are mounted at both ends of the components respectively. One end of each component is folded and these are wound up to make up a battery element, and this is sealed with the flexible external material.

In the sealed battery comprising the planar positive electrode and the planar negative electrode laminated one upon another, electrode conductive tabs are mounted on the laminated positive electrode and the negative electrode respectively. These electrode conductive tabs are sealed individually with the external material and are guided to outside. Or, the electrode conductive tabs are combined as desired and are connected in series or in parallel and are guided to outside. In such case, it is necessary to seal the positive electrode conductive tab or the negative electrode conductive tab at a plurality of points, or to take special care not to electrically connect the positive electrode conductive tab and the negative electrode conductive tab, or not to bring them into contact with the positive electrode or the negative electrode.

JP-11-224652 discloses a battery using a laminated sheet as an external case. In this case, a recessed portion to accommodate the battery is formed on one of the external materials. After placing the laminated battery into it, other external material or a part of the external material is folded to prepare the battery. However, as described in Paragraph 0012 for explaining the invention, a lead connection of the laminated battery is folded and connected as positive electrode lead and negative electrode lead. In a battery comprising many electrodes laminated on each other to maintain battery capacity, it is necessary to fold and bend many lead connections and to overlap them one upon another.

FIG. 5 shows drawings to explain a conventional type sealed battery.

FIG. 5(A) is a perspective view to explain a battery element. A long-size negative electrode and a long-size positive electrode are laminated one upon another with a separator between them, and the laminated combination of electrodes is wound up to make up a battery element 4. I the battery element, one each of a positive electrode conductive tab 5 and a negative electrode conductive tab 6 is bonded to the battery element. One of the conductive tabs, i.e. the positive electrode conductive tab 5 in FIG. 5(A), is positioned at the center of the battery element 4, and the other of the electrode conductive tab, i.e. the negative electrode tab 6, is positioned at peripheral portion of the battery element.

The positive electrode conductive tab 5 positioned at the center is separated by a certain distance from the negative electrode conductive tab, which is positioned on peripheral portion. In this respect, it is necessary to have some process such as folding and bending. It has been practiced in the past in such manner that, after the tab was covered with an insulating member 18, it was folded and bent, and it was sealed with the external material.

FIG. 5(B) is a drawing to show a cross-section along a line perpendicular to winding axis of the battery case. A positive electrode conductive tab 5 and a negative electrode conductive tab 6 are bonded to a positive electrode 7 and a negative electrode 8 respectively. Then, the electrodes are laminated one upon another with a separator between them, and this laminated combination of electrodes is wound up to prepare a battery element 4. The battery element is then fixed using a winding tape to prevent unwinding or loosening. Then, it is pressed to form it in flat shape. It is a wound-type battery element with both surfaces running in horizontal direction.

However, as shown in FIG. 5(C) showing central portion of the battery element, the positive electrode conductive tab 5 is present at the central portion. On peripheral portion of the positive electrode conductive tab 5, a winding defect or winding distortion 19 occurs around the positive electrode conductive tab because of the presence of the tab. Above all, in case of a thin type battery element with fewer number of windings, deformation caused by winding defect of the positive electrode conductive tab plays serious role in the battery element. As a result, there is extensive influence by the winding defect caused by the positive electrode conductive tab 5 at the central portion of the battery element. Where there is winding defect or winding distortion, distribution of electric current is uneven. When electric current is locally concentrated, overheating may occur or the battery may be subject to rapid partial deterioration, and this is not desirable for the performance characteristics of the battery.

It is an object of the present invention to provide a sealed battery, which comprises a positive electrode and a negative electrode laminated one upon another with a separator between them, said electrodes are wound up to prepare a battery element, and the battery element is sealed with a flexible external material, whereby winding distortion or winding defect of the battery element is less conspicuous, and the electrode conductive tab can be easily guided to outside and sealed and this can be performed in perfect manner.

### SUMMARY OF THE INVENTION

The present invention provides a sealed battery, which comprises a battery element sealed with a flexible external material, said battery element being produced by laminating a band-like positive electrode and a band-like negative electrode one upon another via a separator, and the laminated combination of the electrodes is wound, whereby a positive electrode conductive tab and a negative electrode conductive tab are bonded to the positive electrode and the negative electrode respectively at outermost periphery when the electrodes are wound up, and neither of the electrode conductive tabs is present in central portion of the battery element.

Also, the present invention provides a sealed battery as described above, wherein an electrode active material is formed only on inner side of the electrode positioned at outermost periphery of the battery element.

Further, the present invention provides a sealed battery as described above, wherein a coating layer of thermally melting substance or thermally melting film is attached on portions of the positive electrode conductive tab and the negative electrode conductive tab sealed with the external material.

Also, the present invention provides a sealed battery as described above, wherein the battery is accommodated in a recessed portion formed in advance on the flexible external material, and the positive electrode conductive tab and the negative electrode conductive tab are positioned on the surface of the external material and the battery element is sealed.

Further, the present invention provides a method for manufacturing a sealed battery, which comprises the steps of forming a recessed portion to accommodate a battery element on a planar flexible external material, bonding a positive electrode conductive tab and a negative electrode conductive tab at outermost periphery of a positive electrode and a negative electrode respectively when the electrodes are wound up, accommodating the battery element having no electrode conductive tab at central portion of the battery element, and positioning the positive electrode conductive tab and the negative electrode conductive tab on the surface of the external material, and bending the external material and sealing.

Also, the present invention provides a method for manufacturing a sealed battery, which comprises the steps of forming a plurality of recessed portions on a band-like flexible external material, accommodating a battery element in each of the recessed portions, bonding a positive electrode and a negative electrode with a positive electrode conductive tab and a negative electrode conductive tab respectively at outermost periphery when electrodes are wound up, said battery having no conductive tab at central portion thereof, and arranging a band-like external material and sealing.

### BRIEF DESCRIPTION OF THE DRAWINGS

FIG. 1 is a drawing to explain a battery of the present invention showing a perspective view of a battery element of the invention;

FIG. 2 represents drawings to explain a process for manufacturing the battery of the present invention;

FIG. 3 represents drawings to explain another method for manufacturing the battery of the present invention;

FIG. 4 represents drawings to explain still another method for manufacturing the battery of the present invention; and

FIG. 5 represents drawings to explain a conventional type sealed battery.

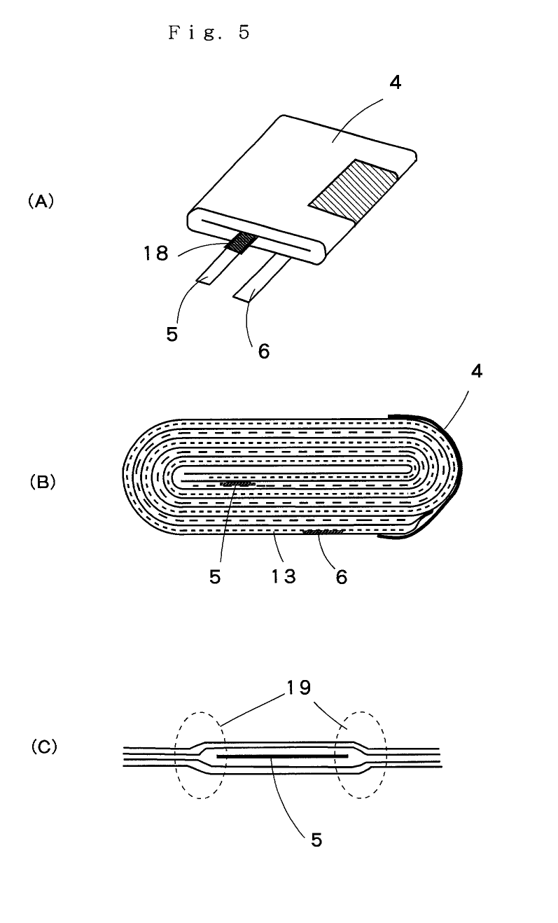

### DETAILED DESCRIPTION OF THE PREFERRED EMBODIMENT

The battery according to the present invention is a sealed battery, which comprises a long-size battery element sealed with a flexible external material. By specifying positions of electrode conductive tabs, it has been found that a battery can be produced, which has satisfactory battery characteristics and in which the electrode conductive tabs can be reliably sealed with an external material.

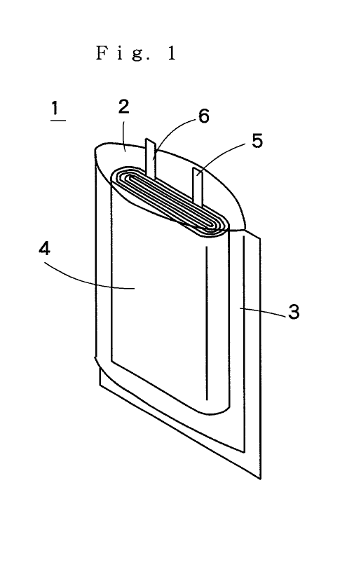

FIG. 1 is a drawing to explain a battery of the present invention, and it is a perspective view of a battery element of the present invention before it is sealed.

A sealed battery of the present invention comprises a battery element 4 accommodated in a battery case 3 having a flexible external material 2. A positive electrode conductive tab 5 and a negative electrode conductive tab 6 are provided at outermost periphery of the electrodes respectively. The positive electrode conductive tab 5 and the negative electrode conductive tab 6 are positioned substantially on the same plane. Therefore, each of the positive electrode conductive tab 5 and the negative electrode conductive tab 6 can be sealed with an external material on the same plane without folding and bending. Moreover, the battery element can be manufactured simply by connecting each of the positive electrode conductive tab and the negative electrode conductive tab regardless of the size of the battery because the battery element is produced by winding up the positive electrode and the negative electrode one upon another.

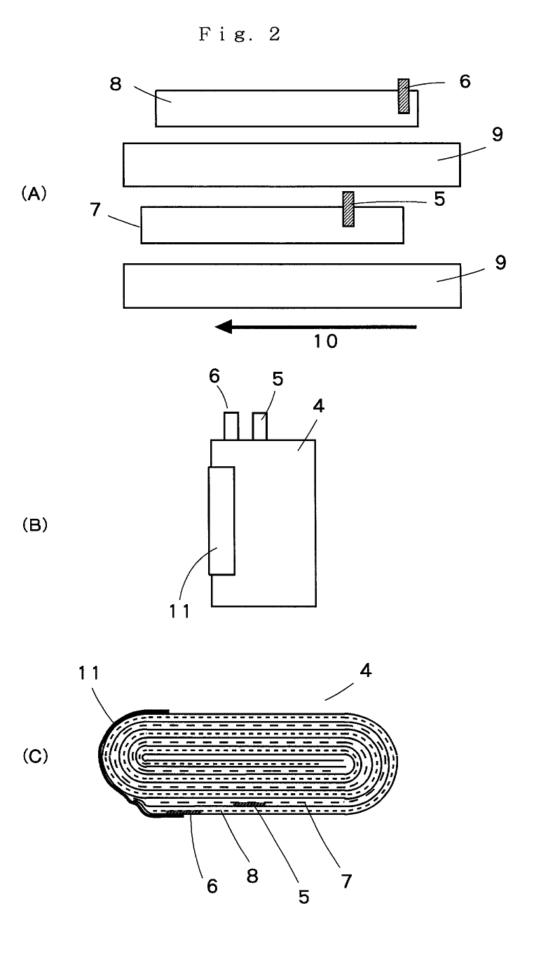

FIG. 2 represents drawings to explain a process for manufacturing the battery of the present invention.

FIG. 2(A) is a development view to explain component members of the battery of the present invention. To a positive electrode 7 and a negative electrode 8, a positive electrode tab 5 and a negative electrode tab 6 are connected respectively by means such as ultrasonic welding, resistance welding, etc. After these components are wound up one upon another in winding direction 10 with a separator 9 between the electrodes, a battery element is produced by fixing with a winding tape 11 to prevent unwinding and loosening of the battery element as shown in FIG. 2(B). Next, the battery element is molded by pressing the battery element or by placing the battery element in a bag made of flexible film, and then, by reducing pressure.

FIG. 2(C) is a view of the battery element thus prepared as seen from above. Because neither the positive electrode conductive tab nor the negative electrode conductive tab is present at the central part of the battery element, no winding distortion or winding defect occurs at the center of the battery element. Moreover, only the separator 6 and the negative electrode 8 are present between the positive electrode conductive tab 5 and the negative electrode conductive tab 6. Because these conductive tabs are positioned substantially on the same plane, the battery element can be sealed without bending the positive electrode conductive tab 5 and the negative electrode conductive tab 6 and can be perfectly sealed.

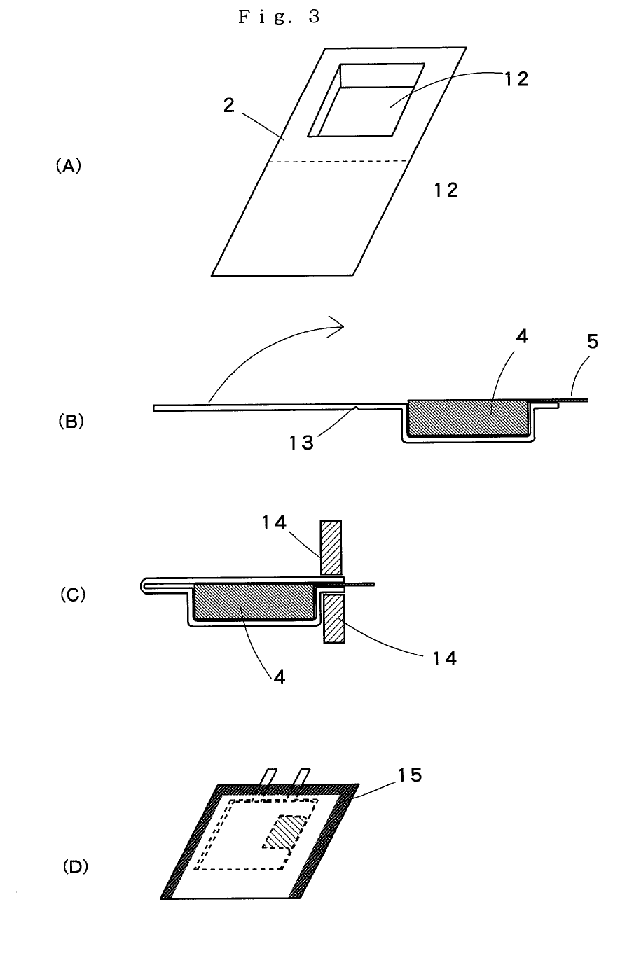

FIG. 3 shows drawings to explain another process for manufacturing the battery of the present invention.

FIG. 3(A) is a drawing of an external material. By pressing and molding the flexible external material 2, a recessed portion to match the battery element is formed.

Next, as shown by the cross-sectional view of FIG. 3(B), a battery element 4 with a positive electrode conductive tab 5 and a negative electrode conductive tab (not shown) on its outer periphery is accommodated in the recessed portion on the external material 2. Because the recessed portion 12 of the external material is in the same size as that of the battery element 4, the positive electrode conductive tab 5 and the negative electrode conductive tab (not shown) are in horizontal direction and come into contact with the surface of the external material.

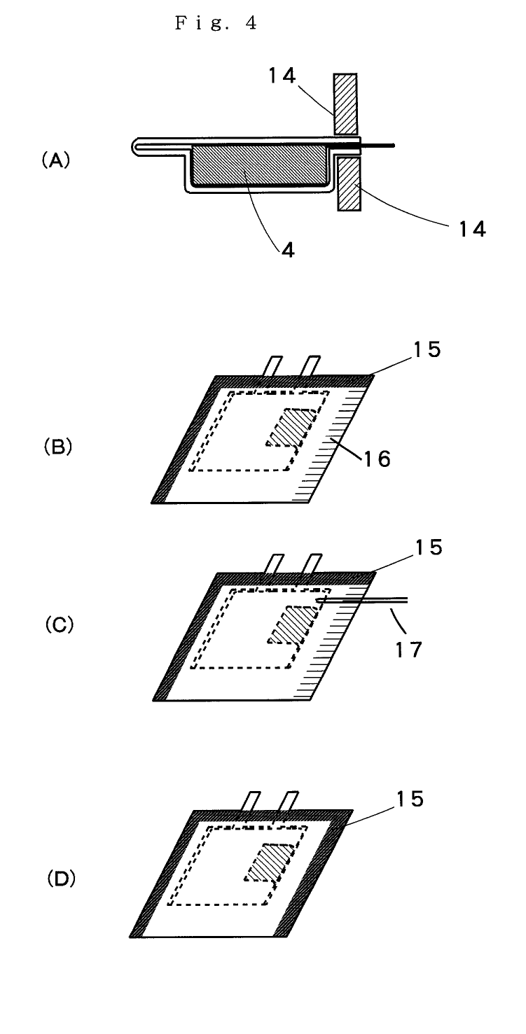

Next, after a predetermined quantity of electrolytic solution is injected into it, the external material is folded and bent at an angle of 180° along a folding line 13 marked on the external material, and the battery element is covered with the external material. Then, it is placed in a pressure reducing device and the air inside is exhausted. Using a thermally melting device 14, peripheral portion of the battery element including the positive electrode conductive tab and the negative electrode conductive tab is thermally melted and it is sealed. As a result, a sealed battery with a thermally melted portion 15 produced by integral heat sealing can be prepared as shown in FIG. 4(C).

In case a bag-like external material is used, at least two sides of a band-like external material are thermally melted by a thermally melting device, and a bag-like external material is prepared. Then, the battery element is accommodated in it, and it is thermally melted by the thermal melting device. Thus, at least two processes are required for heat melting. In contrast, according to the method as explained in connection with FIG. 3, sealing can be achieved by a single heat melting process, and this is more advantageous because it requires less processes.

According to this method, it is necessary to form a recessed portion to accommodate the battery element on the flexible external material. This is much simpler compared with the process to fabricate bag-like form. Also, the accuracy of positioning of the battery element and the external material can be improved.

FIG. 4 shows drawings to explain a method with a different sealing process in the manufacturing method as shown in FIG. 3.

According to the method as shown in FIG. 3, a battery element with the positive electrode conductive tab and the negative electrode conductive tab on its outer periphery is accommodated in the recessed portion of the external material. Then, the external material is bent and is thermally melted on the thermal meting portion using the thermal melting device 14. Thermal melting is not performed on a non-melted portion 16 as shown in FIG. 4(B).

Next, as shown in FIG. 4(C), electrolytic solution is injected into it by electrolytic solution injecting means 17 via the non-melted portion. Then, in a pressure reducing device, the air inside is exhausted and the non-melted portion is thermally melted, and it is perfectly sealed. According to this method, thermal melting process must be performed twice. However, it is more convenient in the manufacturing process because the bending of the external material can be performed before injection of the electrolytic solution.

In connection with FIG. 3 and FIG. 4, description has been given on a method to produce a battery. Specifically, a recessed portion to accommodate a battery element is formed on a part of an external material. Then, a battery element is accommodated in the recessed portion. With the positive electrode conductive tab and the negative electrode conductive tab of the battery element kept in contact with the surface of the external material, one end of the external material is bent and sealed. It may be designed in such manner that sealing can be achieved using an external material different from the external material having the recessed portion. In this case, a plurality of recessed portions may be formed on an external material of long size. A battery element is accommodated in each of the recessed portions. Next, the other external material is placed on it. After thermally melting and sealing this, it may be separated to individual batteries.

The sealed battery of the present invention can be applied to various types of sealed battery such as lithium ion battery, polymer lithium battery, or other types of sealed battery.

An example is taken on the lithium ion battery. To produce the positive electrode, a positive electrode coating material is coated on a band-like aluminum foil using a coating device of the present invention. The positive electrode coating material is prepared as follows: A composite oxide of LiₓMO₂ (where M represents at least one type of transition metal), i.e. LiₓCoO₂, LiₓNiO₂, LiₓMn₂O₄, LiₓMnO₃, LiₓNi_{y}CO_{(1-y)}O₂, etc. is dispersed with a conductive material such as carbon black and a binder such as polyvinylidene fluoride (PVDF) in a solvent such as Nmethyl-2-pyrolidone (NMP) and is kneaded, and the positive electrode coating material is prepared. After coating has been performed on one side, it is dried, and coating is performed on opposite side, and both sides are coated.

To prepare the negative electrode, a negative electrode coating solution is coated on the surface of a band-like copper foil using the coating device of the present invention. To prepare the negative electrode coating solution, following substances are dispersed and kneaded with a binder such as polyvinylidene fluoride (PVDF) in a solvent such as N-methyl-2-pyrolidone (NMP): thermal decomposed carbon for doping and undoping lithium, or cokes such as pitch cokes, needle cokes, petroleum cokes, or graphite, vitreous carbons, etc., or organic macromolecular compound fired products obtained by firing a compound such as phenol resin, furane resin, or carbonaceous substance such as carbon fiber, activated carbon, or conductive macromolecular material such as polyacetylene, polypyrole, etc. or lithium alloy such as metal lithium, lithium-aluminum alloy, or conductive substance such as carbon black. After coating has been performed on one side, it is dried, and coating is performed on opposite side, and both sides are coated.

When the battery element is produced by winding up electrodes, if the negative electrode does not come to a position opposite to the positive electrode active material layer, the negative electrode active material may be coated only on one side.

Next, the negative electrode conductive tab and the positive electrode conductive tab are connected to the negative electrode and the positive electrode respectively by ultrasonic welding, resistance welding, etc. Then, these are wound up using a winding device, and the battery element thus prepared is fixed by the winding tape, and the battery element is molded to a predetermined form by pressing it.

The external material to be used for the sealed battery of the present invention can be prepared as follows: On one side of an aluminum foil on inner surface of the battery, a thermoplastic resin layer is attached via an adhesive layer or without adhesive layer by thermal melting process. As the thermoplastic resin layer, the following materials may be used: polyethylene, polypropylene, ionomer, ethylene-methacrylate copolymer resin, ethylene-(meth)acrylate copolymer resin, etc. On the opposite side, polyester resin such as polyethylene terephthalate or nylon resin are laminated.

When moisture enters the battery case through connecting surface of polyethylene, polypropyrene, etc. on inner side, the material such as LiPF₆ used as electrolyte may be decomposed, and hydrofluoric acid may be generated. This adversely affects the battery active material of the battery or may corrode aluminum of the external material. In this sense, it is very important to maintain performance characteristics of the sealed surface for long time.

To improve thermal melting property of the sealed surface, non-stretched polyethylene film with good melting property may be used as the film on inner surface. Or, at least, maleic acid denatured olefin resin layer may be formed on the sealed surface.

Further, on the portions where the positive electrode conductive tab and the negative electrode conductive tab come into contact with the external material, maleic acid olefin may be coated in advance for surface treatment, or it may be coated with maleic acid olefin film to increase bonding strength with the external material.

[Embodiment]

Description will be given below on an embodiment of the present invention.

### EXAMPLE 1

A polyethylene film was laminated on one side of an aluminum foil and a polyester film was laminated on the other side, and a laminated film was prepared. On this laminated film, a recessed portion with size of 26×26×4.9 mm (length×width×depth) was formed by press molding, and a battery element of lithium ion battery of 4.9 mm in thickness was accommodated into the recessed portion. The battery element had a positive electrode conductive tab and a negative electrode conductive tab each of 0.1 mm in thickness only on its outer periphery, and the conductive tabs were substantially on the same plane. Thermal melting was performed on the laminated film except a part of it, and electrolytic solution was injected via the non-melted portion. Then, thermal melting was performed in a pressure reducing device, and perfect sealing was performed.

As a result, a lithium ion battery was prepared, which was perfectly sealed and had no surface irregularities caused by the positive electrode conductive tab or the negative electrode conductive tab and had good external appearance.

In the battery of the present invention, the positive electrode conductive tab and the negative electrode conductive tab are positioned substantially on the same plane on outer periphery of the battery element. When it is sealed with flexible external material, perfect sealing can be performed without bending neither of the conductive tabs. Neither of the conductive tabs is present at the central portion of the battery element, and no defective winding of the battery element is caused by the presence of the conductive tabs. Thus, homogeneous battery element can be prepared, and a thin type battery with satisfactory characteristics can be obtained.

What is claimed is:

1. A sealed battery, comprising a battery element sealed with a flexible external material, said battery element being produced by laminating a band-like positive electrode and a band-like negative electrode one upon another via a separator, and the laminated combination of the electrodes is wound, whereby a positive electrode conductive tab and a negative electrode conductive tab are bonded to the positive electrode and the negative electrode respectively at outermost periphery when the electrodes are wound up, and neither of the electrode conductive tabs is present in central portion of the battery element.

2. A sealed battery according to claim 1, wherein an electrode active material is formed only on inner side of the electrode positioned at outermost periphery of the battery element.

3. A sealed battery according to claim 1, wherein a coating layer of thermally melting substance or thermally melting film is attached on portions of the positive electrode conductive tab and the negative electrode conductive tab sealed with the external material.

4. A sealed battery according to claim 1, wherein the battery is accommodated in a recessed portion formed in advance on the flexible external material, and the positive electrode conductive tab and the negative electrode conductive tab are positioned on the surface of the external material and the battery element is sealed.

5. A sealed battery according to claim 1, wherein the battery is a lithium ion battery.

6. A method for manufacturing a sealed battery, comprising the steps of forming a recessed portion to accommodate a battery element on a planar flexible external material, bonding a positive electrode conductive tab and a negative electrode conductive tab at outermost periphery of a positive electrode and a negative electrode respectively when the electrodes are wound up, accommodating the battery element having no electrode conductive tab at central portion of the battery element, and positioning the positive electrode conductive tab and the negative electrode conductive tab on the surface of the external material, and bending the external material and sealing.

7. A method for manufacturing a sealed battery, comprising the steps of forming a plurality of recessed portions on a band-like flexible external material, accommodating a battery element in each of the recessed portions, bonding a positive electrode and a negative electrode with a positive electrode conductive tab and a negative electrode conductive tab respectively at outermost periphery when electrodes are wound up, said battery having no conductive tab at central portion thereof, and arranging a band-like external material and sealing.
